(19) United States
(12) Patent Application Publication
(10) Pub. No.: US 2009/0223645 A1
(43) Pub. Date: Sep. 10, 2009

(54) Method and composition for improved temporary wet strength

(76) Inventors: Naijie Zhang, Ridgefield, CT (US); Michael Ryan, Newtown, CT (US); Robert J. Proverb, Woodbury, CT (US)

Correspondence Address: CANTOR COLBURN, LLP, 20 Church Street, 22nd Floor, Hartford, CT, 06103, US

(21) Appl. No.: 11/887,045

(22) PCT Filed: Mar. 17, 2006
(86) PCT No.: PCT/US2006/009681

§ 371 Date: Nov. 11, 2008

Related U.S. Application Data
(60) Provisional application No. 60/664,780, filed on Mar. 24, 2005.

(51) Int. Cl. D21H 17/46; C08L 77/00

(52) U.S. Cl. 162/164.6; 525/421

(57) ABSTRACT

A composition comprising a polymer that is a reaction product of: a copolymer backbone comprising; (i) at least one acrylamide component, (ii) at least one co-monomer, (iii) at least one initiator and (iv) at least one chain transfer agent; and at least one cellulose reactive agent; wherein the copolymer backbone and cellulose reactive agent are combined with water to form a solution wherein the concentration of the copolymer backbone is about 0.1 to about 19% by weight based on the total weight of the solution. A process to make high solids copolymer backbone with low molecular weight and narrow molecular weight distribution has also been developed by a continuous polymerization process under refluxing conditions. In this process, a mixture of the acrylamide, co-monomer and chain transfer agent and the initiator are simultaneously and continuously added to a heel of water.

### CROSS REFERENCES AND RELATED APPLICATIONS

The application claims priority from provisional application No. 60/644,780 entitled “METHOD AND COMPOSITION FOR IMPROVED TEMPORARY WET STRENGTH”, filed on Mar. 24, 2005, herein incorporated by reference in its entirety.

### BACKGROUND

Temporary wet strength resins are used extensively as temporary wet- and dry-strength additives in tissuemaking industries.

U.S. Pat. No. 4,605,702 to Guerro discloses water-soluble glyoxalated acrylamide copolymers as temporary wet strength additives. The backbone of polyacrylamide for temporary wet strength polymers is made by the adiabatic process in which acrylamide copolymers are prepared using a batch process by the solution copolymerization of acrylamide with a cationic monomer in the presence of a chain transfer agent. These polymers are subsequently reacted with glyoxal in a dilute, aqueous solution to impart —CONHCHOHCHO functionalities onto the polymer and to increase the molecular weight of the polymer through glyoxal cross-linking. This glyoxalation is normally carried out at greater than 20% solids.

In a batch process acrylamide and chain transfer catalysts are added at once to monomer solution making the reaction difficult to control. The reaction temperature increases to the boiling point of water resulting in the polymer backbone with maximum of 30% solids. In addition, excess monomer must be used in this process due to the lower reactivity of the monomer in order to produce the desired polymer composition (95 mol % acrylamide/5 mol % monomer). This process also takes more than three hours to complete and results in a high level of residual monomer in the backbone. Therefore, it is desirable to develop an easily controllable process that can make the high solids backbone and reduce organic waste. The new process should certainly reduce the shipping and period costs and increase the capacity for the storage. Furthermore, the new process can result in cost-saving in raw materials and make products that are environmentally friendly as well as highly efficient temporary wet strength resins.

### SUMMARY

Embodiments of the present invention include a composition that may include a polymer that contains the reaction product of a copolymer backbone that may include at least one acrylamide component, at least one co-monomer, at least one initiator, and at least one chain transfer agent. The copolymer is reacted with at least one cellulose reactive agent in water to form an aqueous solution wherein the concentration of the copolymer backbone during reaction may be between 0.1 to about 19% by weight of the aqueous solution and, in certain embodiments, from about 8 to about 16% polymer solids. In certain embodiments, the acrylamide, chain transfer agent and the initiator may be added to an aqueous mixture of the co-monomer continuously, and the copolymerization results in a copolymer backbone with a molecular weight of from about 500 to about 6000 daltons.

In embodiments of the present invention, the acrylamide, initiator, chain transfer agent and the cellulose reactive agent are in an amount sufficient to produce a copolymer that imparts highly efficient temporary wet strength to a fibrous substrate when the polymer is added to paper stock during paper making. Embodiments of the invention include polymers with a backbone that may have a molecular weight of from about 1000 to about 4000 daltons.

In some embodiments, the acrylamide is from about 10 to about 99% based on the total weight of the copolymer, and in others, the acrylamide component is from about 70 to about 90% based on the total weight of the copolymer backbone.

The copolymer used in the present invention may include any cationic co-monomer or anionic comonomer, or diallyl dimethylammonium chloride, methacryloyloxytrimethylammonium chloride, methyacrylamidopropyl trimethylammonium chloride, 1-methacryloyl-4-methyl peprazine or combinations thereof.

The chain transfer agent of the present invention may be 2-mercaptoethanol, lactic acid, isopropyl alcohol, thioacids, sodium hypophosphite and combinations thereof, and may be about 0.1 to about 15% based on the total weight of the copolymer backbone, in some embodiments, and about 0.1 to about 10% based on the total weight of the copolymer in others.

The initiator of the present invention may be ammonium persulfate, azobisisobutyronitrile, 2,2′-azobis(2-methyl-2-amidinopropane) dihydrochloride, ferrous ammonium sulfate hexahydrate, sodium sulfite, sodium metabisulfite, and combinations thereof and, in certain embodiments, may be from about 0.1 to about 30% based on the total weight of the copolymer backbone.

The composition may also contain a multifunctional cross-linking co-monomer that may be from about 0 to about 5% of the total weight of the copolymer backbone.

In embodiments of the present invention, the cellulose reactive agent may be glyoxal, gluteraldehyde, furan dialdehyde, 2-hydroxyadipaldehyde, succinaldehyde, dialdehyde, dialdehyde starch, diepoxy compounds and combinations thereof.

The present invention also embodies methods of making a polymer in which at least one acrylamide, at least one co-monomer, at least one initiator and at least one chain transfer agent may be mixed in an aqueous solution. The aqueous mixture of the acrylamide, co-monomer, initiator and chain transfer agent may be copolymerized to make a polymer with a polymer backbone of about 500 to about 6000 daltons or, in other embodiments, from about 1000 to about 4000 daltons. The polymer may then be reacted with a cellulose reactive agent in an aqueous solution wherein the concentration of the copolymer backbone is from about 0.1 to about 19% by weight of the entire solution to make a cellulose reactive polymer and may be added to paper stock during a papermaking process providing a paper product with efficient temporary wet strength.

In some embodiments of the present invention, the co-polymer may be from about 10 to about 99% based on the total weight of the copolymer and, in others, from about 0.1 to about 15% based on the total weight of the copolymer.

The composition may also include a multifunctional cross-linking co-monomer that is form about 0 to about 5% based on the total weight of the copolymer.

The initiator may be from about 0.1 to about 30% based on the total weight of the monomers in some embodiments of the invention.

Another embodiment of the invention is a method that may include contacting paperstock during the papermaking process with a polymer that includes at least one acrylamide, at least one co-monomer, at least one initiator, at least one chain transfer agent and at least one cellulose reactive agent wherein the copolymer backbone and cellulose reactive agent are combined in an aqueous solution wherein the concentration of the copolymer may be from about 0.1 to about 19% by weight of the solution.

### DESCRIPTION OF FIGURES

FIG. 1. graphically illustrates the relationship between the percent glyoxalation polymer solids and initial wet tensile strength.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “polymer” is a reference to one or more polymers and equivalents thereof known to those skilled in the art, and so forth.

Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

As used herein, the term “about” means plus or minus 10% of the numerical value of the number with which it is being used. Therefore, about 50% means in the range of 45%-55%. Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

A new two-step process for making a functionalized water soluble, cationic, anionic or amphoteric thermosetting, cellulose reactive polymer has been developed that imparts high efficient temporary wet strength to fibrous substrate when the polymer is added to paper stock during the papermaking. In the first step of the process, a polymer backbone is made by continually adding a mixture of acrylamide, chain transfer agent and initiator, to an aqueous mixture of co-monomer. A cellulose reactive agent is added to the polyacrylamide of the first step which adds a moiety to the polyacrylamide that allows it to bind to cellulose. The resulting copolymer may then be added to paper stock during the papermaking process to give the paper improved temporary wet strength.

The polymer backbone of the present invention is a high solids acrylamide copolymer backbone with low molecular weight and narrow molecular weight distribution that is made using a continuous monomer feeding process under refluxing conditions. In this process, acrylamide is mixed with a chain transfer agent, and this mixture and a separate initiator feed are continuously added to the heel of an aqueous solution of a cationic co-monomer under refluxing conditions. Alternatively, the polymer backbone may be made by continuously feeding an acrylamide, co-monomer solution, a chain transfer agent and an initiator into the heel of water. The process is completed in three hours and produces a copolymer backbone with solids up to 50% by weight of the copolymer.

The polymer backbone made by the continuous process of the present invention has improved qualities. The copolymers produced using the continuous process have improved molecular weight and charge distribution within the copolymer backbone when compared with copolymers produced using the conventional batch process, and GPC results show that copolymers made by the continuous process exhibit narrower polydispersity (Table 1). Performance testing results show that glyoxalated polyacrylamide made with polyacrylamide produced by the continuous process perform better then glyoxalated polyacrylamide made by the conventional batch process, and, without wishing to being bound by theory, these improvements can be attributed to the improved molecular weight and charge distributions (Table 2). Furthermore, the co-monomer concentration can be reduced 20-40% from the original formulation using the continuous process resulting in a polymer with lower residual co-monomer concentration that complies with FDA regulations, i.e. for example 95 mol % acrylamide and 5 mol % DADMAC.

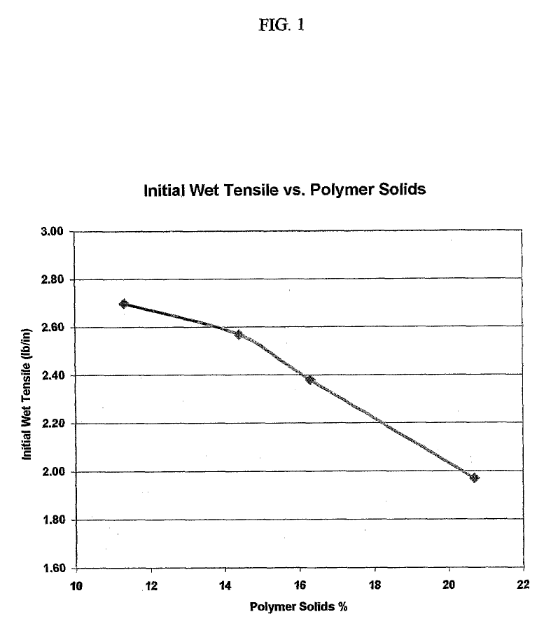

Besides the effect of molecular weight and charge distributions on the performance, the polymer solids during the reaction of the copolymer backbone with a cellulose reactive agent also plays a key role in enhancing the resin efficiency. Glyoxal is a common cellulose reactive agent used in copolymer resins that impart wet strength to paper products, and the process by which the glyoxal is added to the copolymer backbone is commonly referred to as glyoxalation. According to the glyoxalation procedure from U.S. Pat. No. 4,605,702, polymer solids during glyoxalation are greater than 20%. The current invention is based on the discovery that lowering the polymer solids during glyoxalation increases the resin efficiency. In fact, the lower polymer solids content during glyoxalation, the higher the resins efficiency. For example, a resin glyoxalated with a backbone made either by a continuous process or a batch process polymer solids content of below 20% exhibits higher immediate wet tensile strength than the resin glyoxalated at greater than 20% solids (Table 34 and FIG. 1). In addition, HPGPC (high performance gel permeation chromatography) results show that a resin glyoxalated at lower polymer solids has higher molecular weight (MW) than a resin glyoxalated at higher polymer solids (Table 5).

The concentration of glyoxal affects the reaction rate as well as the degree of the glyoxalation. The rate of glyoxalation of polyacrylamide can be defined as:

Glyoxlation Rate a K[Glyoxal]^{2.1}[Polyacrylamide]^{2.7}

Therefore, decreasing the polyacrylamide concentration decreases the glyoxalation rate. However, increasing the glyoxal concentration can compensate for a low polyacrylamide concentration increasing the glyoxalation. Additionally, the degree of substitution of polyacrylamide can be increased improving performance of the copolymer by increasing the glyoxal concentration and lowering the polyacrylamide concentration (Table 6).

A glyoxalated polymer made using the continuous process described herein shows higher efficiency than the polymer made by conventional batch process and imparts improved wet strength to paper products to which the polymer is added. However, the improved wet strength is temporary. Therefore, the paper product made using the polymer will exhibit high initial wet strength but rapid tensile decay when it is soaked in water for a short period of time making the resin a potential component of for example but not limited to bathroom tissue. In fact, bath tissue containing the resin also exhibits high dispersibility and high flushibility. The paper products containing glyoxalated polymer made using the continuous method also exhibit better performance at high pH then comparable paper products using polymers made by using the batch process.

The current invention also encompasses chain transfer agents that are less toxic, less expensive, and less odorous than the commonly used 2-mercaptoethanol. To explore these chain transfer agents, a series of acrylamide-DADMAC backbones were synthesized using a variety of chain transfer agents. Chain transfer agents that are non-toxic, cheaper, and easier to handle than 2-mercaptoethanol were selected, non-limiting examples of such include sorbitol sodium hypophosphite, sodium formate, glyoxal, glyoxylic acid, and benzyl alcohol. All of the chain transfer agents used resulted in a higher molecular weight backbone with the exception of sodium hypophosphite. The glyoxalation products of polyacrylamides made using these chain transfer agents exhibited poorer tensile decay compared with 2-mercaptoethanol presumably because of high molecular weight backbone. However, a glyoxalated polyacrylamide made using sodium hypophosphite as a chain transfer agent shows similar performance to 2-mercaptoethanol (Table 7). Besides being non-toxic and easy to handle, sodium hypophosphite is less costly than 2-mercaptoethanol, and the glyoxalated polyacrylamide made using sodium hypophosphite is odor- and color-free.

Overall, the continuous copolymerization process of the present invention makes a copolymer with improved molecular weight and charge distribution (narrow PDI), high solids polymer backbone, temperature controlled, more environmentally friendly, increased storage capacity, has lower residual monomers, is more cost effective, has improved performance, and high efficiency.

The acrylamide component includes those polymers formed from acrylamide and/or methacrylamide or an acrylamide copolymer containing acrylamide and/or methacrylamide as a predominant component among all monomers making up the copolymer.

In preferred embodiments of the present invention when the copolymer is employed as a paper strengthening agent, the acrylamide polymer contains 50 mole % or more acrylamide and/or methacrylamide.

In a particularly preferred embodiment, the acrylamide polymer is from 74 to 99.97 mole % or from 94 to 99.98 mole % of the total copolymer.

The amount of the acrylamide component generally ranges from 70 to 99%, based on the total weight of the copolymer, and in one embodiment, the acrylamide component ranges from 75 to 95% by weight of the total copolymer.

Acrylamide co-monomers of the structured polymers may be replaced by other co-monomers by up to about 10% by weight of the acrylamide. Co-monomers that may replace other co-monomers include but are not limited to acrylic acid, acrylic esters such as ethyl acrylate, butyl acrylate, methylmethacrylate, and 2-ethylhexyl acrylate, acrylonitrile, N,N′-dimethyl acrylamide, N-tert-butyl acrylamide, 2-hydroxyethyl acrylate, styrene, vinylbenzene sulfonic acid, vinyl pyrrolidon and combinations of these.

The co-monomer of the present invention is generally a cationic comonomer which, when used in accordance to the invention, produces a polymer in accordance to the invention. Non-limiting examples of suitable cationic co-monomers include diallyl dimethylammonium chloride, acryloyloxytrimethylammonium chloride, methacryloyloxytrimethylammonium chloride, methacrylamidopropyl trimethylammonium chloride, 1-methacryloyl-4-methyl piperazine, and combinations of these. The amount of the co-monomer generally ranges from 1 to 30%, more preferably from 5 to 25% based on the total weight of the copolymer.

The molecular weight of the backbone produced using the process described herein may vary. In one embodiment, the backbone has a molecular weight, prior to reaction with the cellulose reactive agent component, ranging from 500 to 6000 daltons, more preferably from 1000 to 4000 daltons. The molecular weights reported herein are weight averages.

The bulk viscosity of the copolymer may vary depending on application Generally, the viscosity of the copolymer is in the range of 10-200 cps, more particularly from 15-100 cps at 44% total solids.

The chain transfer agent ranges from 0.1-15% more particularly from 1 to 10%. The suitable transfer agents include but are not limited to 2-mercaptoethanol; lactic acid; isopropyl alcohol; thioacids; sodium hypophosphite, preferably 2-mercaptoethanol, sodium hypophosphite and lactic acid and combinations of these.

Multifunctional cross-linking monomers may optionally be added and include any multifunctional cross-linking agent which, when used in conjunction with the invention, produces a doubly structured backbone such that the glyoxalated polymer imparts strength to a fibrous substrate when the polymer is added to paper stock during a papermaking process. Generally, a multifunctional cross-linking agent may be present in an amount ranging from 0 to 5%, or more particularly from 0 to 1%. Suitable multifunctional cross-linking monomers include but are not limited to methylenebisacrylamide; methylenebismethacrylamide; triallylammonium chloride; tetraallylammonium chloride; polyethyleneglycol diacrylate; polyethyleneglycol dimethacrylate; N-vinyl acrylamide; divinylbenzene; tetra(ethylene glycol) diacrylate; dimethylallylaminoethylacrylate ammonium chloride; diallyloxyacetic acid, sodium salt; diallyloctylamide; trimethylolpropane ethoxylate triacrylate; N-allylacrylamide N-methylallylacrylamide, and combinations of these. Further examples of suitable monomers can be found in: WO 97/18167 and U.S. Pat. No. 4,950,725, incorporated herein by reference in its entirety.

In one embodiment of the current invention, the amount of multifunctional cross-linking monomer is at least 20 ppm, more particularly from 20 to 20,000 ppm.

In a particularly preferred embodiment, the amount of multifunctional cross-linking co-monomer is from 100 to 1,000 ppm (Table 8).

This invention and embodiments illustrating the method and materials used may be further understood by reference to the following non-limiting examples.

### Example 1

### Copolymer Backbone

### Batch Process

A suitable 3-necked reaction vessel, equipped with a Claisen adaptor, reflux condenser, mechanic stirrer, thermometer, nitrogen sparge and inlet with serum cap is charged with 142.4 g of 53.08% acrylamide, 200 g of water and 28.6 g of 65.2% diallyldimethylammonium chloride. The pH is adjusted to 4.0 with 10% sulfuric acid. The solution is sparged with nitrogen while stirring for 30 minutes. To the vessel is then charged 8.5 g of the 2-mercaptoethanol. Sparging is continued for ten minutes and is then interrupted. At once is added 12.3 g of 15% ammonium persulfate. An exothermal release of heat ensues, the maximum temperature of 73° C. is achieved within three minutes. The reaction is maintained at 70° C. for 2 hours by a heating bath. The booster catalyst, consisting 7.75 g of 15% ammonium persulfate is added to the solution. The polymer solution is stirred for 60 minutes at 70° C. and then the heating bath is removed and the solution allowed cool yielding 26.5% polymer solids.

### Glyoxalation

At ambient temperature, 100 g of 26.5% backbone prepared above is treated with 21.7 g of 40% glyoxal and 38.3 g water, in a suitable 3-necked vessel equipped with a mechanical stirrer. While stirring; the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 2

### Copolymer Backbone

### Continuous Process

A 500 ml three neck round-bottom reaction flask equipped with a condenser, Claisen adapter, thermometer, stirrer bearing and stirrer rod was charged with 21.5 g water. The water was heated to reflux by using an oil bath. To a 200 ml jar, 142.2 g of 53.14% acrylamide, 23 g of 65% diallyldimethylammonium chloride, and 0.3 g citric acid were added. The pH of solution mixture was adjusted to pH 4.0 by 10% sulfuric acid. Under stirring, 8.8 g 2-mercaptoethanol was added and the mixture further stirred for 5 minutes. Under refluxing conditions, the above monomer mixture and 24 g of 15% ammonium persulfate were simultaneously, continuously fed into the water heel in 100 minutes. After that, the reaction was maintained for 35 minutes under refluxing conditions and then 7 g of 15% ammonium persulfate was added continuously in 10 minutes to lower the residual monomers. The polymer solution was further stirred for 35 minutes and then cooled down to 40° C. Total reaction time is 180 minutes. The pH of the polymer solution was adjusted to pH 4.0 by 10% sodium hydroxide yielding 46% polymers solids.

### Glyoxalation

At ambient temperature, 60 g of 46% backbone prepared above is treated with 22.7 g of 40% glyoxal and 83.3 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 3

### Glyoxalation

At ambient temperature, 60 g of the backbone of EXAMPLE 2 is treated with 22.7 g of 40% glyoxal and 87.3 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 4

### Glyoxalation

At ambient temperature, 60 g of the backbone of EXAMPLE 2 is treated with 22.7 g of 40% glyoxal and 106.3 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 5

### Glyoxalation

At ambient temperature, 100 g of the backbone of EXAMPLE 2 is treated with 46.3 g of 40% glyoxal and 247 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 6

### Glyoxalation

At ambient temperature, 100 g of the backbone of EXAMPLE 1 is treated with 22 g of 40% glyoxal and 38 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 7

### Copolymer Backbone

### Continuous Process

A 500 ml three neck round-bottom reaction flask equipped with a condenser, Claisen adapter, thermometer, stirrer bearing and stirrer rod was charged with 40 g water. The water was heated to reflux by using an oil bath. To a 200 ml jar, 142.4 g of 53.14% acrylamide, 23 g of 65.2% diallyldimethylammonium chloride, 5.4 g of 0.5% methylenebisacrylamide, and 0.5 g citric acid were added. The pH of solution mixture was adjusted to pH 4.0 by 10% sulfuric acid. Under stirring, 7.4 g of 98% 2-mercaptoethanol was added and the mixture further stirred for 5 minutes. Under refluxing conditions, the above monomer mixture and 20 g of 15% ammonium persulfate were simultaneously, continuously fed into the water heel in 100 minutes. After that, the reaction was maintained for 45 minutes under refluxing conditions and then 3.5 g of 15% ammonium persulfate was added continuously in 10 minutes to lower the residual monomers. The polymer solution was further stirred for 35 minutes and then cooled down to 40° C. Total reaction time is 190 minutes. The pH of the polymer solution was adjusted to pH 4.0 by 10% sodium hydroxide yielding 39.4% polymers solids.

### Glyoxalation

At ambient temperature, 60 g of 39.4% backbone prepared above is treated with 25.7 g of 40% glyoxal and 126.3 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 8

### Copolymer Backbone

A 500 ml three neck round-bottom reaction flask equipped with a condenser, Claisen adapter, thermometer, stirrer bearing and stirrer rod was charged with 200 g water. The water was heated to reflux by using an oil bath. To a 200 ml jar, 142.2 g of 53.14% acrylamide, 23 g of 65% diallyldimethylammonium chloride, and 0.5 g citric acid were added. The pH of solution mixture was adjusted to pH 4.0 by 10% sulfuric acid. Under stirring, 8.8 g 2-mercaptoethanol was added and the mixture further stirred for 5 minutes. Under refluxing conditions, the above monomer mixture and 24 g of 15% ammonium persulfate were simultaneously, continuously fed into the water heel in 100 minutes. After that, the reaction was maintained for 45 minutes under refluxing conditions and then 7 g of 15% ammonium persulfate was added continuously in 10 minutes to lower the residual monomers. The polymer solution was further stirred for 35 minutes and then cooled down to 40° C. Total reaction time is 190 minutes. The pH of the polymer solution was adjusted to pH 4.0 by 10% sodium hydroxide yielding 25.6% polymers solids.

### Glyoxalation (25% Glyoxal Based on Total of Polymer and Glyoxal)

At ambient temperature, 110 g of 25.6% backbone prepared above was treated with 23.5 g of 40% glyoxal and 36.5 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 9

### Copolymer Backbone

A 500 ml three neck round-bottom reaction flask equipped with a condenser, Claisen adapter, thermometer, stirrer bearing and stirrer rod was charged with 200 g water. The water was heated to reflux by using an oil bath. To a 200 ml jar, 142.2 g of 53.14% acrylamide, 23 g of 65% diallyldimethylammonium chloride, and 0.5 g citric acid were added. The pH of solution mixture was adjusted to pH 4.0 by 10% sulfuric acid. Under stirring, 8.8 g 2-mercaptoethanol was added and the mixture further stirred for 5 minutes. Under refluxing conditions, the above monomer mixture and 24 g of 15% ammonium persulfate were simultaneously, continuously fed into the water heel in 100 minutes. After that, the reaction was maintained for 45 minutes under refluxing conditions and then 7 g of 15% ammonium persulfate was added continuously in 10 minutes to lower the residual monomers. The polymer solution was further stirred for 35 minutes and then cooled down to 40° C. Total reaction time is 190 minutes. The pH of the polymer solution was adjusted to pH 4.0 by 10% sodium hydroxide yielding 25.6% polymers solids.

### Glyoxalation (33% Glyoxal Based on Total of Polymer and Glyoxal)

At ambient temperature, 100 g of 25.6% backbone prepared above was treated with 32 g of 40% glyoxal and 43 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

### Example 10

### Glyoxalation

At ambient temperature, 100 g of 26.5% backbone of EXAMPLE 1 was treated with 22 g of 40% glyoxal and 98.8 g water, in a suitable 3-necked vessel equipped with a mechanical stirrer. While stirring, the pH is adjusted to 8.3-8.5 and maintained at this level with 10% sodium hydroxide. The viscosity is monitored using a #3 Shell cup until 26 seconds is achieved. The reaction is then quenched by the addition of 10% H₂SO₄, until a pH of 3.2 is reached.

TABLE 1
High Solids AMD-DADMAC Backbone

| EXAMPLE | Solids % | Mn | Mw | Mw/Mn |
|---|---|---|---|---|
| 1a (batch process in plant) | 30 | 466 | 2342 | 5.026 |
| 2 (continuous process in plant) | 45 | 709 | 1589 | 2.242 |
| 1b (batch process in lab) | 30 | 928 | 3041 | 3.275 |
| 2a (continuous process in lab) | 30 | 1869 | 2316 | 1.239 |
| 2b (continuous process in lab) | 40 | 1251 | 1894 | 1.515 |
| 2c (continuous process in lab) | 45 | 1260 | 1952 | 1.549 |

TABLE 2
Batch Process vs. Continuous Process

| | | | Initial | | |
|---|---|---|---|---|---|
| | | | Wet | Dry | |
| | | Dosage | Tensile | Tensile | % Decay |
| EXAMPLE | pH | lb/T | (lb/In) | (lb/In) | (30 mins) |
| Blank | 7 | 0 | 0.31 | 13.64 | n/a |
| 1 | 7 | 6 | 1.33 | 16.18 | 69 |
| batch process; 16.6% | 7 | 8 | 1.68 | 16.75 | 66 |
| glyoxalation polymer solids | | | | | |
| 2 | 7 | 6 | 1.57 | 15.59 | 67 |
| continuous process; 16.6% | 7 | 8 | 1.85 | 16.69 | 64 |
| glyoxalation polymer solids | | | | | |

* 75 gsm basis weight

TABLE 3
Glyoxalation Polymer Solids Effect by Continuous Process

| | | | Initial | | |
|---|---|---|---|---|---|
| | | | Wet | Dry | |
| | | Dosage | Tensile | Tensile | % Decay |
| EXAMPLE | pH | lb/Ton | (lb/in) | (lb/in) | (30 mins) |
| Blank | 6 | 0 | 0.57 | 18.58 | 63 |
| Produced as U.S. Pat. No. | 6 | 6 | 1.97 | 20.68 | 69 |
| 4,605,702 | | | | | |
| 20.7% Polymer solids | 7 | 6 | 1.75 | 20.83 | 71 |
| 3 | 6 | 6 | 2.38 | 22.48 | 66 |
| 16.3% Polymer solids | 7 | 6 | 1.89 | 21.55 | 66 |
| 4 | 6 | 6 | 2.57 | 23.35 | 62 |
| 14.4% Polymer solids | 7 | 6 | 2.01 | 23.35 | 65 |
| 5 | 6 | 6 | 2.70 | 23.64 | 61 |
| 11.3% Polymer solids | 7 | 6 | 2.25 | 23.11 | 61 |

* 75 gsm basis weight

TABLE 4
Glyoxalation Polymer Solids Effect by Batch Process

| | | | Initial | | |
|---|---|---|---|---|---|
| | | | Wet | Dry | |
| | | Dosage | Tensile | Tensile | % Decay |
| EXAMPLE | pH | (lb/Ton) | (lb/in) | (lb/in) | (30 mins) |
| Produced as U.S. Pat. No. | 7 | 6 | 1.43 | 19.26 | 76 |
| 4,605,702 | | | | | |
| 20.7% glyoxalation | | | | | |
| polymer solids | | | | | |
| 6 | 7 | 6 | 1.71 | 20.44 | 66 |
| 16.6% glyoxalation | | | | | |
| polymer solids | | | | | |
| 10 | 7 | 6 | 2.13 | 22.21 | 59 |
| 12% glyoxalation | | | | | |
| polymer solids | | | | | |

* 75 gsm basis weight

TABLE 5
MW vs. Glyoxalation Polymer Solids

| | % Glyoxalation | | | |
|---|---|---|---|---|
| EXAMPLE | Polymer Solids | Mw | Mn | Mw/Mn |
| Produced as | 20.7 | 224,300 | 17240 | 13.1 |
| U.S. Pat. No. 4,605,702 | | | | |
| 4 | 14.4 | 619,300 | 53420 | 11.6 |
| 5 | 11.3 | 1,778,000 | 195600 | 9.1 |

TABLE 6
Glyoxal level Effect

| | | | Initial | | |
|---|---|---|---|---|---|
| | | | Wet | Dry | |
| | | Dosage | Tensile | Tensile | Decay % |
| EXAMPLE | pH | (lb/Ton) | (lb/in) | (lb/in) | (30 mins) |
| Blank | 5.7 | 0 | 0.50 | 14.83 | 70 |
| 8 | 5.7 | 6 | 1.94 | 16.78 | 65 |
| 25% glyoxal | 5.7 | 8 | 2.25 | 18.10 | 66 |
| | 5.7 | 10 | 2.62 | 18.47 | 66 |
| 9 | 5.7 | 6 | 2.07 | 17.67 | 70 |
| 33% glyoxal | 5.7 | 8 | 2.34 | 18.27 | 68 |
| | 5.7 | 10 | 2.89 | 18.86 | 65 |

*Glyoxal level is based on the total of polymer and glyoxal
*75 gsm basis weight

TABLE 7
Chain Transfer Agents

| | | | | | | Tensile |
|---|---|---|---|---|---|---|
| | | | | | | Decay |
| | | | | Initial | Soaked | % |
| | | | | Wet | Tensile | (30 |
| | Chain Transfer | Dosage | | Tensile | 30 mins | mins) |
| Resin | Agent | (lb/Ton) | pH | (lb/in) | (lb/in) | (lb/in) |
| PAREZ 745 | HSCH₂CH₂OH | 6 | 5.7 | 1.30 | 0.55 | 58 |
| | | 10 | 5.7 | 1.72 | 0.77 | 55 |
| B82150-50A | HCOCOOH | 6 | 5.7 | 0.69 | 0.37 | 46 |
| | | 10 | 5.7 | 0.98 | 0.44 | 55 |
| B82150-50E | NaH₂PO₂ | 6 | 5.7 | 1.44 | 0.55 | 62 |
| | | 10 | 5.7 | 1.99 | 0.74 | 63 |
| B82150-50G | C₆H₅CH₂OH | 6 | 5.7 | 1.32 | 0.69 | 48 |
| | | 10 | 5.7 | 1.81 | 1.00 | 45 |
| B82150-50L | HCOONa | 6 | 5.7 | 1.36 | 0.96 | 29 |
| | | 10 | 5.7 | 1.79 | 1.02 | 43 |
| B82150-50M | PhCH2OH | 6 | 5.7 | 1.24 | 0.65 | 48 |
| | | 10 | 5.7 | 1.86 | 1.01 | 46 |

* 75 gsm basis weight

TABLE 8
Structured GPAM

| | | | Initial | | |
|---|---|---|---|---|---|
| | | Dosage | Wet Tensile | Dry Tensile | % Decay |
| EXAMPLE | pH | (lb/Ton) | (lb/in) | (lb/in) | (30 mins) |
| 6 | 5.7 | 6 | 1.64 | 16.65 | 60 |
| | 5.7 | 10 | 1.91 | 18.05 | 53 |
| 7 | 5.7 | 6 | 2.03 | 17.63 | 61 |
| | 5.7 | 10 | 2.46 | 19.07 | 59 |

* 75 gsm basis weight

Although the present invention has been described in considerable detail with reference to certain preferred embodiments thereof other versions are possible. Therefore the spirit and scope of the appended claims should not be limited to the description and the preferred versions contained within this specification.

1. A composition comprising a polymer that is a reaction product of:
a copolymer backbone comprising; (i) at least one acrylamide component, (ii) at least one co-monomer, (iii) at least one initiator and (iv) at least one chain transfer agent; and
at least one cellulose reactive agent;
wherein the copolymer backbone and cellulose reactive agent are combined with water to form a solution wherein the concentration of the copolymer backbone is about 0.1 to about 19% by weight based on the total weight of the solution.

2. The composition of claim 1, wherein the acrylamide, the initiator, the chain transfer agent and the cellulose reactive agent are in an amount sufficient to produce a polymer that imparts highly efficient temporary wet strength to a fibrous substrate when the polymer is added to paper stock during a papermaking process.

3. The composition of claim 1, wherein the concentration of copolymer backbone is from about 8 to about 16% by weight based on the total weight of the solution.

4. The composition of claim 1, wherein the copolymer backbone is made by a batch process comprising adding the initiator to a mixture comprising the acrylamide, the co-monomer, and the chain transfer agent.

5. The composition of claim 1, wherein the copolymer backbone is made by a continuous process whereby a mixture of the acrylamide and chain transfer agent and the initiator are simultaneously and continuously added to a heel of co-monomer aqueous solution.

6. The composition of claim 1, wherein the copolymer backbone is made by a continuous process whereby a mixture of the acrylamide, co-monomer and chain transfer agent and the initiator are simultaneously and continuously added to a heel of water.

7. The composition of claim 1, wherein the copolymer backbone is made by a stepwise process.

8. The composition of claim 1, wherein the copolymer backbone has a molecular weight of from about 500 to about 6000 daltons.

9. The composition of claim 1, wherein the copolymer backbone has a molecular weight of from about 1000 to about 4000 daltons.

10. The composition of claim 1, wherein the acrylamide component is from about 10 to about 99% by weight of the copolymer backbone.

11. The composition of claim 1, wherein the acrylamide component is from about 70 to about 90% by weight of the copolymer backbone.

12. The composition of claim 1, wherein the co-monomer is selected from cationic comonomers, anionic co-monomers, diallyl dimethylammonium chloride, methacryloyloxytrimethylammonium chloride, methyacrylamidopropyl trimethylammonium chloride, 1-methacryloyl-4-methyl piperazine and combinations thereof

13. The composition of claim 1, wherein the chain transfer agent is selected from 2-mercaptoethanol, lactic acid, isopropyl alcohol, thioacids, sodium hypophosphite and combinations thereof.

14. The composition of claim 1, wherein the chain transfer agent is from about 0.1 to about 15% by weight of the copolymer backbone.

15. The composition of claim 1, wherein the chain transfer agent is from about 0.1 to about 10% by weight of the copolymer backbone.

16. The composition of claim 1, wherein the initiator is selected from, ammonium persulfate, azobisisobutyronitrile, 2,2′-azobis(2-methyl-2-amidinopropane) dihydrochloride, ferrous ammonium sulfate hexahydrate, sodium sulfite, sodium metabisulfite, and combinations thereof.

17. The composition of claim 1, wherein the initiator is from about 0.1 to about 30% by weight of the copolymer backbone.

18. The composition of claim 1, further comprising a multifunctional cross-linking co-monomer wherein the multifunctional cross-linking co-monomer is from about 0.1 to about 5% by weight of the copolymer backbone.

19. The composition of claim 1, wherein the cellulose reactive agent is selected from glyoxal, gluteraldehyde, furan dialdehyde, 2-hydroxyadipaldehyde, succinaldehyde, dialdehyde, dialdehyde starch, diepoxy compounds and combinations thereof.

20. The composition of claim 1, wherein the cellulose reactive agent is from about 10 to about 100% by weight of the copolymer backbone.

21. The composition of claim 1, wherein the cellulose reactive agent is from about 20 to about 50% by weight of the copolymer backbone.

22. A method comprising:
mixing at least one acrylamide, at least one co-monomer and at least one chain transfer agent in an aqueous solution;
copolymerizing the aqueous mixture of the acrylamide, the co-monomer and the chain transfer agent with the addition of an initiator whereby a copolymer is made;
reacting the copolymer with a cellulose reactive agent in an aqueous solution wherein the concentration of the copolymer is about 0.1 to about 19% by weight based on the total weight of solution whereby a cellulose reactive copolymer is made; and
contacting a paper stock during a papermaking process with the cellulose reactive copolymer whereby a paper product with highly efficient temporary wet strength is produced.

23. The method of claim 22, wherein the mixing further comprises addition of components by method selected from step-wise addition, batch-wise additions, continuous addition or combinations thereof.

24. The method of claim 22, wherein the copolymer has a molecular weight of from about 500 to about 6000 daltons.

25. The method of claim 22, wherein the acrylamide component is from about 10 to about 99% by weight of the copolymer.

26. The method of claim 22, wherein the chain transfer agent is from about 0.1 to about 15% by weight of the copolymer.

27. The method of claim 22, further comprising a multifunctional cross-linking comonomer wherein the multifunctional cross-linking co-monomer is from about 0.1 to about 5% by weight of the copolymer.

28. The method of claim 22, wherein the initiator is from about 0.1 to about 30% by weight of the copolymer.

29. A method comprising:
contacting paper stock during a papermaking process with a cellulose reactive copolymer comprising:
at least one copolymer comprising: (i) at least one acrylamide component, (ii) at least one co-monomer (iii) at least one initiator, and (iv) at least one chain transfer agent; and
at least one cellulose reactive agent wherein the copolymer and reactive agent are mixed in an aqueous solution wherein the concentration of the copolymer is about 0.1 to about 19% by weight based on the total weight of solution.

30. A paper made using the process of claim 29.
